(19) United States
(12) Patent Application Publication
(10) Pub. No.: US 2010/0324193 A1
(43) Pub. Date: Dec. 23, 2010

(54) A PROCESS FOR THE PRODUCTION OF NANODISPERSIBLE BOEHMITE AND THE USE THEREOF IN FLAME RETARDANT SYNTHETIC RESINS

(75) Inventors: Rene G.E. Herbiet, Eupen (BE); Monika Giesselbach, Koln (DE)

Correspondence Address: ALBEMARLE CORPORATION;PATENT DEPARTMENT, 451 FLORIDA STREET, BATON ROUGE, LA, 70801, US

(73) Assignee: ALBEMARLE CORPORATION, BATON ROUGE, LA (US)

(21) Appl. No.: 12/867,518

(22) PCT Filed: Feb. 5, 2009
(86) PCT No.: PCT/EP2009/000801

§ 371 Date: Aug. 13, 2010

Related U.S. Application Data
(60) Provisional application No. 61/029,613, filed on Feb. 19, 2008.

(51) Int. Cl. C09K 21/02; C09K 21/14

(52) U.S. Cl. 524/437; 252/609

(57) ABSTRACT

The present invention relates to processes for the production of at least partially pepetizable and at least partially peptized boehmite particles, the at least partially pepetizable and at least partially peptized boehmite particles, and the use of the at least partially peptized boehmite particles to flame retard synthetic resins.

### FIELD OF THE INVENTION

The present invention relates to a process for the production of nanodispersible boehmite flame-retardants, the nanodispersible boehmite particles produced therefrom and their use.

### BACKGROUND OF THE INVENTION

Boehmite, an aluminum oxide hydroxide commonly represented by the formula AlO(OH), is a flame retardant filler that finds use as, among other things, a flame retardant in a variety of synthetic resins. Methods for the synthesis of boehmite are well known in the art. For example, WO 2005/100245 teaches that boehmite can be produced by the hydrothermal treatment of aluminum hydroxide, a bayerite/gibbsite mixture. Though these boehmites improve the flame retardant performance of plastic compounds, a drawback of these boehmite fillers is that even when used at lower loadings, the translucency of the compound is lost, which might be a drawback in certain applications where good flame retardant performance and good translucency is desirable.

Thus, the demand for tailor made boehmite grades is increasing, and the current processes are not capable of producing these grades. Therefore, there is an increasing demand for superior boehmite grades and methods for their production.

### BRIEF DESCRIPTION OF THE FIGURES

FIGS. 1 and 2 are pictures depicting the translucence improvement in an ethylene vinyl acetate compound when using boehmite particles according to the present invention. FIG. 1 depicts the translucency of an EVA compound filled with 75 phr of the inventive filler produced in Example 1. FIG. 2 depicts the translucency of an EVA compound filled with 75 phr of the inventive filler produced in Example 2

FIGS. 3 and 4 are pictures depicting the opacity of an ethylene vinyl acetate compound when using comparative boehmite particles. FIG. 3 depicts the opacity of an EVA compound filled with 75 phr of the comparative filler produced in Example 3. FIG. 4 depicts the opacity of an EVA compound filled with 75 phr of the comparative filler produced in Example 4.

FIG. 5 is a picture depicting the opacity of an ethylene vinyl acetate compound filled with 75 phr of the commercially available magnesium hydroxide filler Magnifin® H 5.

FIG. 6 is a picture depicting the opacity of an ethylene vinyl acetate compound filled with 75 phr of commercially available aluminum hydroxide filler Martinal® OL-104 LE.

FIG. 7 is an SEM photograph showing the shape of boehmite particles according to the present invention.

### SUMMARY OF THE INVENTION

The present invention relates to a process comprising heating a mixture containing at least aluminum hydroxide particles and in the range of from about 1 to about 40 wt % of a partially, preferably substantially totally, peptized boehmite, based on the total weight of the aluminum hydroxide particles, in the presence of water and one or more base crystal growth regulators to one or more temperatures of at least about 160° C. thereby producing agglomerated boehmite particles. The agglomerated boehmite particles thus produced are at least partially, preferably substantially totally, peptizable.

In the practice of the present invention, it is preferred that the heating be conducted under pressures greater than atmospheric pressure.

In preferred embodiments, the agglomerated boehmite particles thus produced can be recovered by, for example, filtration, and then subjected to a drying treatment thereby producing boehmite product particles.

In the practice of the present invention, the agglomerated boehmite particles can also be at least partially peptized, and then dried.

### DETAILED DESCRIPTION OF THE INVENTION

### Aluminum Hydroxide

Aluminum hydroxide has a variety of alternative names such as aluminum hydrate, aluminum trihydrate etc., but is commonly referred to as ATH. In the practice of the present invention, ATH particles are subjected to a treatment in the presence of water and one or more crystal growth regulators.

It should be noted that all particle diameter measurements, i.e. d₅₀ values, disclosed herein, unless otherwise specified, were measured by laser diffraction using a Cilas 1064 L laser spectrometer from Quantachrome. Generally, the procedure used herein to measure the d₅₀, can be practiced by first introducing a suitable water-dispersant solution (preparation see below) into the sample-preparation vessel of the apparatus. In the software “Particle Expert”, the measurement model “Range 1” is selected, referring to apparatus-internal parameters that apply to the expected particle size distribution. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

The ATH particles used in the practice of the present invention can be generally characterized as having i) a BET in the range of from about 1 to about 100 m²/g; ii) a d₅₀ in the range of from about 0.1 to about 60 μm; or combinations of i) and ii).

In some embodiments, the ATH particles used in the practice of the present invention have a BET in the range of from about 10 to about 60 m²/g, preferably in the range of from about 20 to about 40 m²/g. In an exemplary embodiment, the BET of the ATH particles used in the present invention is in the range of from about 25 to about 35 m²/g,

In some embodiments, the ATH particles used in the practice of the present invention have a d₅₀ in the range of from about 0.1 to about 30 μm, more preferably in the range of from about 0.1 to about 10 μm. In an exemplary embodiment, the d₅₀ is in the range of from about 0.1 to about 4 μm. In some embodiments, ATH particles used in the practice of the present invention have a d₅₀ in the range of from about 0.5 to about 4 μm, more preferably in the range of from about 1 to about 3 μm, most preferably in the range of from about 1.5 to about 2.5 μm.

The ATH particles used in the practice of the present invention are preferably already present in an aqueous suspension. If the ATH particles are dried particles, water and/or a dispersing agent, such as those described below, can be added to provide for an aqueous suspension.

In some embodiments, the ATH particles in the aqueous suspension, or the ATH particles used to produce the aqueous suspension, are pure gibbsite or a bayerite/gibbsite mixture, preferably a bayerite/gibbsite mixture. The bayerite portion in such a bayerite/gibbsite mixture is typically at least about 50 wt. %, preferably at least about 70 wt. %, more preferably at least about 80 wt. %, and in an exemplary embodiment, at least about 90 wt. %, all based on the total weight of the bayerite/gibbsite mixture. If a bayerite-/gibbsite mixture is used, the gibbsite portion can be at least about 5 wt. %, with the remainder being bayerite, sometimes in the range of from about 20 to about 25 wt. % gibbsite, both based on the total weight of the bayerite/gibbsite mixture.

The bayerite used as starting material can for example be produced according to the method described in EP 1 206 412 B1, see in particular the disclosure on page 3, paragraph 21 of that document. If required, gibbsite is added in the desired amount, and the BET surface area and the particle size can be adjusted beforehand by appropriate choice of crystal precipitation conditions of the gibbsite and if necessary grinding to the desired range.

The amount of ATH particles present in the aqueous suspension used in the present invention is generally in the range of from about 1 to about 30 wt. %, preferably in the range of from about 5 to about 20 wt.-%, more preferably in the range of from about 6 to about 10, wt. %, based on the total weight of the suspension, i.e. water and aluminum hydroxide. In an exemplary embodiment, the aqueous suspension contains in the range of from about 7 to about 9 wt. % ATH particles, on the same basis.

### Partly Peptizable Boehmite

The at least partly peptized boehmite used in the practice of the present invention serves as seed particles in some embodiments of the present invention and can be combined with the ATH particles, typically the ATH suspension, in any suitable manner. The at least partly peptized boehmite is typically in the form of a sol, and thus, the sol and the ATH suspension can be combined in any manner; for example, the sol can be combined with the ATH suspension or vice versa. In some embodiments, such as when the at least partly peptized boehmite is substantially completely peptized, the sol comprises substantially no unpeptized boehmite. In other embodiments, such as when the at least partly peptized boehmite is not substantially completely peptized, the sol also comprises a certain quantity of unpeptized boehmite. The total amount of boehmite added to the ATH suspension, in the form of a sol or in the form of a sol that also comprises a certain quantity of unpeptized boehmite, is in the range of from about 1 to about 40 wt. %, based on the total weight of the ATH particles. In some embodiments, the total amount of at least partly peptizable boehmite added to the ATH suspension is in the range of from about 10 to about 30 wt. %, based on the total weight of the ATH particles. In some embodiments the total amount of at least partly peptizable boehmite added to the ATH suspension is in the range of from about 5 to about 30 wt. %, preferably in the range of from about 8 to about 20 wt. %, both quantities based on the total weight of the ATH particles.

The at least partly peptized boehmite used in the practice of the present invention, before it is peptized according to the peptizing process described below, can be generally characterized as having: i) a BET in the range of from about 70 to about 400 m²/g; ii) a d₅₀ greater than 0.02 μm; iii) is peptizable by at least about 30% by the method described below; or any combinations of i), ii), iii). In an exemplary embodiment the at least partly peptized boehmite, before it is peptized, is characterized by i), ii), and iii).

In some embodiments, the BET of the at least partly peptized boehmite is in the range of from about 200 to about 300 m²/g, preferably in the range of from about 250 to about 300 m²/g. In an exemplary embodiment, the BET of the at least partly peptizable boehmite used in the present invention is in the range of from about 280 to about 300 m²/g.

In some embodiments, the at least partly peptizable boehmite is peptizable by at least about 50%, preferably by at least about 70%, most preferably by at least about 90%. In an exemplary embodiment, the at least partly peptized boehmite is substantially completely peptizable, i.e. peptizable by about 100%.

While the method described above is using nitric acid to characterize the peptizability of the boehmite, for the synthesis of the inventive boehmite product particles according to the present invention, other inorganic acids or chemical products known in the art like organic acids, inorganic and organic bases or salts can be used for peptization. Suitable, non-limiting examples of other inorganic acids are hydrochloric acid, phosphoric acid and the like. When using other chemical products than nitric acid for peptization, the grade of peptization is determined in the same manner as described above. For chemical products resulting in pH values below 7, the lowest limit for the pH value is set to 1. For chemical products resulting in pH values above 7, the highest limit for the pH value is set to 12. Non-limiting examples of suitable organic acids include fumic, acetic, citric, and the like. In some embodiments, the organic acid used is acetic acid. In other embodiments, the inorganic acid used is nitric acid.

In some embodiments, the at least partly peptized boehmite used as the seed herein has a d₅₀ greater than 0.04 μm. In some embodiments, the at least partly peptized boehmite used as the seed herein has a d₅₀ in the range of from about 0.02 to about 2 μm, preferably in the range of from about 0.05 to about 1 μm, more preferably in the range of from about 0.08 to about 0.5 μm. It should be noted that the d₅₀ measurements of the at least partly peptized boehmite used herein are suitably measured by laser diffraction using the Beckman Coulter LS 13 320 particle size analyzer according to ISO 13320. The following procedures are followed when obtaining the d₅₀ measurements of the at least partly peptized boehmite: A suitable water-dispersant solution of the same pH as the peptized boehmite particles is filled into the Beckman Coulter LS 13 320 particle size analyzer and a background measurement is taken. Approximately 0.5 g of the at least partly peptized boehmite is briefly dispersed in the same water-dispersant solution used in obtaining the background measurement(s) thus forming a suspension. This suspension is introduced into the apparatus by means of a pipette until the optimal measurement concentration is reached, which is given by the manufacturer. In the application software, the appropriate parameters for the sample, i.e. the refractive index and measurement conditions including the PIDS detectors for the nano range, are chosen. 5 Minutes of ultrasonic treatment are applied to the suspension. Subsequently, the size distribution data are collected in the interval of 90 s and analyzed according to Mie scattering theory. This procedure is repeated with 5 min. of ultrasonic treatment between each run until the particle size distribution does not change with further application of ultrasonic. In the case of peptized particles, it is essential that the dispersing solution used has the same pH as the peptized sol, therefore the equipment is filled with water acidified by the peptizing acid, e.g. nitric or acetic acid, to the same pH as the sol. No further addition of dispersing agent is necessary in this case.

By peptization, it is meant the formation of a colloidal solution (i.e. a sol) by addition of electrolytes to particles in a liquid. Suitable electrolytes are for example acids, bases or salts. Thus, in the practice of the present invention, “peptization” refers to the addition of a suitable electrolyte to a boehmite-containing slurry. The boehmite-containing slurry can contain any amount of boehmite as described above when discussing the ATH aqueous suspension, and the boehmite-containing slurry may also contain a dispersing agent, such as those described below. In some embodiments, the boehmite-containing slurry is produced by combining at least partly peptizable boehmite particles, as described below, water, a dispersing agent, or a combination of water and a dispersing agent. In some embodiments, the boehmite-containing sol is produced by combining at least partly peptizable boehmite particles, water, a dispersing agent, or a combination of water and dispersing agent, with an acid, a base or a salt, such as those described below when discussing the crystal growth regulator.

In the practice of the present invention, the grade of peptization of a boehmite can be measured by adding concentrated nitric acid to a 10 wt. % boehmite suspension in deionized water at room temperature under stirring using a stirrer. By definition, the grade of peptization of the boehmite is 100%, if all boehmite particles in the suspension can be transferred to a colloidal solution at room temperature at a pH value above or equal to 1. The grade of peptization is lower than 100% if boehmite particles remain unpeptized even when the pH is equal to 1. The grade of peptization can then be determined as follows: While stirring the obtained solution comprising the sol and the boehmite particle suspension in a beaker to obtain a uniform slurry, a suitable volume V of the slurry is removed from the beaker by means of a pipette and centrifuged in a centrifuge at about 5000 rpm for about 10 minutes. The weight Wₜₒₜ of the total boehmite content (i.e. peptized and unpeptized) in said volume V can be calculated, knowing that the initial boehmite suspension contained 10 wt. % of boehmite and taking into account the volume of the nitric acid added. After centrifugation, the sol is removed by means of a pipette without removing boehmite particles sedimented at the bottom of the solution. The flask comprising the unpeptized boehmite particles is then dried in an oven at 105° C. during 24 h. The weight difference between the dried flask containing the dried, unpeptized boehmite particles and the weight of the empty flask gives the weight Wᵤ of the unpeptized boehmite particles present in the volume V of the slurry in the flask prior to centrifugation. The grade of peptization P is then obtained by dividing the weight difference between the weight Wₜₒₜ of the total boehmite content present in the volume V in the flask prior to centrifugation and the weight Wᵤ of the unpeptized boehmite particles by the weight Wₜₒₜ of the total boehmite content:

P=(Wₜₒₜ−Wᵤ)·100%/Wₜₒₜ (1)

### Crystal Growth Regulator

In the practice of the present invention, the combination of the ATH particles and the at least partly peptized boehmite are treated, sometimes referred to herein as a hydrothermal treatment, in the presence of water and one or more base crystal growth regulators. Base crystal growth regulators suitable for use herein may be any basic crystal growth regulator known in the art such as alkali or alkaline oxides or hydroxides and the like.

Non-limiting examples of suitable base crystal growth regulators include sodium hydroxide, potassium hydroxide, calcium hydroxide, calcium oxide, sodium oxide and magnesium oxide.

The amount of base crystal growth regulator used herein will be such that the resulting pH value of the solution is in the range of from about 8 to about 14, or about 10 to about 14, preferably in the range of from about 11 to about 13.

### Hydrothermal Treatment

In the practice of the present invention, the ATH aqueous suspension, the at least partly peptized boehmite and crystal growth regulator are subjected to a hydrothermal treatment. The hydrothermal treatment is conducted at one or more temperatures of at least 160° C., at one or more pressures above about atmospheric pressure, i.e. 1.01325 bar, for a period of time sufficient to produce agglomerated boehmite particles, which can be dried, as described below, to produce boehmite product particles, as described below.

In preferred embodiments, the hydrothermal treatment is conducted at one or more temperatures in the range of from about 160° C. to about 340° C., more preferably at one or more temperatures in the range of from about 170° C. to about 250° C. In an exemplary embodiment, the hydrothermal treatment is conducted at one or more temperatures in the range of from about 160° C. to about 215° C.

In some embodiments, the hydrothermal treatment is conducted at one or more pressures in the range of from about 1.01325 to about 152 bar, preferably at one or more pressures in the range of from about 7 to about 152 bar, more preferably at one or more pressures in the range of from about 9 to about 43 bar. In an exemplary embodiment, the hydrothermal treatment is conducted at one or more pressures in the range of from about 7 to about 23 bar.

In some embodiments, the hydrothermal treatment is conducted for a period of time of up to about 2 days. In some embodiments, the hydrothermal treatment is conducted for a period of time in the range of from about 10 minutes, preferably about 15 minutes, more preferably about 30 minutes, most preferably about 1 hour, to about 2 days, preferably up to about 24 hours, more preferably up to about 5 hours. In another embodiment, the treatment is conducted for a period of time a) in the range of from about 10 minutes to about 2 days; b) in the range of from about 15 minutes to about 24 hours; c) in the range of from about 30 minutes to about 24 hours; or d) in the range of from about 1 hour to about 5 hours. In an exemplary embodiment, the hydrothermal treatment is conducted for a period of time in the range of from about 1 hour to about 5 hours.

After the hydrothermal treatment is complete, the aqueous product suspension containing at least partially peptizable boehmite particles in the form of agglomerates, thus referred to sometimes herein as agglomerated boehmite particles or agglomerated at least partially peptizable boehmite particles, is optionally cooled or allowed to cool, preferably to room temperature or to a temperature which allows for recovering the agglomerated at least partially peptizable boehmite particles, from the aqueous product suspension by, for example, filtration. The recovered agglomerated boehmite particles can then be washed one or more times with water, optionally at least partially peptized, and then dried to produce boehmite product particles, as described below. Non-limiting examples of suitable drying techniques include mill drying, belt drying, spray drying, and the like.

In some embodiments, the agglomerated at least partially peptizable boehmite particles can be at least partially peptized prior to drying. Thus, in some embodiments, an acid or base is added to the aqueous product suspension before the at least partially peptizable boehmite particles are recovered therefrom to at least partly peptize the agglomerated boehmite particles in the aqueous product solution. In these embodiments, the amount of acid or base added to the aqueous product suspension is that amount sufficient to achieve and/or maintain a pH within the range of from about 1 to about 5, preferably in the range of from about 2 to about 4, if an acidic compound is used. If a base is used, the amount of base used will be such that the resulting pH value of the aqueous product solution is in the range of from about 10 to 14, preferably in the range of from about 11 to about 13. It should be noted that the amount of acid or base added to achieve these pH values can vary each time since the resulting pH value of the aqueous product solution is dependent on various factors including, for example, the acid or base concentration used, even typical concentrations are different for each species of acid or base; the strength of the acid or base used, which is typically different for each acid or base; and any fluctuations in the starting pH of the aqueous product solution to which the acid or base is added. After peptization, the at least partially peptized boehmite product particles can be recovered by any suitable filtering/recovery techniques capable of recovering solids from a sol, and then dried.

In some embodiments, the at least partially peptizable boehmite particles can be recovered from the aqueous product suspension, optionally washed one or more times with water, and re-slurried using water, a dispersing agent, or a combination thereof, as described above. The re-slurried, agglomerated at least partially peptizable boehmite particles can then be at least partially peptized using an acid or a base, as described above. After peptization, the at least partially peptized boehmite product particles can be recovered, as described above, and then dried according to any of the techniques described below. It should be noted that after the agglomerated boehmite particles are at least partially peptized, the degree of agglomeration of the at least partially peptized boehmite particles is less than the agglomerated boehmite particles.

“Mill-drying” and “mill-dried” as used herein, is meant that the boehmite particles recovered from the aqueous suspension, i.e. either the agglomerated boehmite particles or the at least partially peptized boehmite particles if the agglomerated particles are at least partially peptized prior to drying, sometimes referred to herein simply as the recovered boehmite particles, are dried in a turbulent hot air-stream in a mill drying unit. The mill-drying unit comprises a rotor that is firmly mounted on a solid shaft that rotates at a high circumferential speed. The rotational movement in connection with a high air through-put converts the through-flowing hot air into extremely fast air vortices which take up the recovered boehmite particles, accelerate them, and distribute and dry them. After having been dried completely, the boehmite product particles are transported via the turbulent air out of the mill and separated from the hot air and vapors by using suitable filter systems. In another embodiment of the present invention, after having been dried completely, the boehmite product particles are transported via the turbulent air through an air classifier which is integrated into the mill, and are then transported via the turbulent air out of the mill and separated from the hot air and vapors by using conventional suitable filter systems.

In a preferred embodiment, the boehmite particles recovered from the aqueous suspension, e.g. either the agglomerated boehmite particles or the at least partially peptized boehmite particles if the agglomerated particles are at least partially peptized prior to drying, particles are spray dried. Spray drying is a technique that is used in the production of boehmite. This technique generally involves the atomization of a boehmite feed, here the recovered boehmite particles, through the use of nozzles and/or rotary atomizers. The atomized feed is then contacted with a hot gas, typically air, and the spray dried boehmite product particles are then recovered from the hot gas stream. The contacting of the atomized feed can be conducted in either a counter or co-current fashion, and the gas temperature, atomization, contacting, and flow rates of the gas and/or atomized feed can be controlled to produce boehmite product particles having desired product properties, as described below.

If the recovered boehmite particles are spray dried, the recovered boehmite particles are reslurried, and the resulting slurry is spray dried. The recovered boehmite particles can be reslurried through the use of water, a dispersing agent, or any mixtures thereof. If the recovered boehmite particles are re-slurried through the use of water, the slurry generally contains in the range of from about 1 to about 40 wt. % boehmite particles, based on the total weight of the slurry, preferably in the range of from about 5 to about 40 wt. %, more preferably in the range of from about 8 to about 35 wt. %, most preferably in the range of from about 8 to about 25 wt. %, all on the same basis. If the recovered boehmite particles are reslurried with a dispersing agent or a combination of a dispersing agent or water, the slurry may contain up to about 50 wt. % recovered boehmite particles, based on the total weight of the slurry, because of the effects of the dispersing agent. In this embodiment, the remainder of the slurry, i.e. not including the recovered boehmite particles and the dispersing agent(s), is typically water, although some reagents, contaminants, etc. may be present from precipitation. Thus, in this embodiment, the slurry typically comprises in the range of from 1 to about 50 wt. % recovered boehmite particles, based on the total weight of the slurry, preferably the slurry comprises in the range of from about 10 to about 50 wt. %, more preferably in the range of from about 20 to about 50 wt. %, most preferably in the range of from about 25 to about 40 wt. %, recovered boehmite particles, based on the total weight of the slurry. Non-limiting examples of dispersing agents suitable for use herein include polyacrylates, organic acids, naphtalensulfonate/formaldehyde condensate, fatty-alcohol-polyglycol-ether, polypropylene-ethylenoxid, polyglycol-ester, polyamine-ethylenoxid, phosphate, polyvinylalcohole.

The recovery of the boehmite product particles can be achieved through the use of recovery techniques such as filtration or just allowing the “spray-dried” particles to fall to collect in the spray drier where they can be removed, but any suitable recovery technique can be used. In preferred embodiments, the boehmite product particles are recovered from the spray drier by allowing it to settle, and screw conveyors recover it from the spray-drier and subsequently convey through pipes into a silo by means of compressed air.

The spray-drying conditions are conventional and are readily selected by one having ordinary skill in the art with knowledge of the desired boehmite product particles qualities, described below. Generally, these conditions include inlet air temperatures between typically 250 and 550° C. and outlet air temperatures typically between 105 and 150° C.

### Boehmite Product Particles

The boehmite product particles, i.e. the boehmite particles collected after the recovered boehmite particles have been dried, produced by the present invention can be described generally by: i) a BET specific surface area, as determined by DIN-66132, in the range of from about 20 to about 300 m²/g; ii) a maximum loss on ignition (LOI) of about 20% at a temperature of 1200° C.; iii) a 2% weight loss at a temperature equal or higher than about 250° C. and a 5% weight loss at a temperature equal or higher than about 330° C.; iv) at least partly peptizable; v) as having a crystallite size between 10 and 25 nm; vi) an aspect ratio of less than about 2:1; or vii) any combinations of two or more of i)-vi). In an exemplary embodiment, the boehmite product particles are described by all of i)-vi).

Weight loss, as used herein, refers to release of water of the dried boehmite particles and can be assessed directly by several thermoanalytical methods such as thermogravimetric analysis (“TGA”), and in the present invention, the thermal stability of the dried boehmite particles was measured via TGA. Prior to the measurement, the boehmite product particle samples were dried in an oven for 4 hours at 105° C. to remove surface moisture. The TGA measurement was then performed with a Mettler Toledo TGA/SDTA 851^{e} by using a 70 μl alumina crucible (initial weight of about 180 mg) under N₂ (25 ml per minute) with a heating rate of 1° C. per min. The TGA temperature of the dried boehmite particles (pre-dried as described above) was measured at 2 wt. % loss and 5 wt. % loss, both based on the weight of the dried boehmite particles. It should be noted that the TGA measurements described above were taken using a lid to cover the crucible.

In some embodiments, the boehmite product particles have a BET specific surface in the range of from about 50 to about 200 m²/g, preferably in the range of from about 70 to about 180 m²/g. In exemplary embodiments, the boehmite product particles have a BET specific surface of in the range of from about 80 to about 150 m²/g.

As stated above, in some embodiments, the boehmite product particles produced by the present invention can be characterized as being at least partly peptizable. By at least partly peptizable when used to describe the boehmite product particles, it is meant that the grade, or degree, of peptizability of the boehmite product particles is at least 30% using acetic acid at a pH value not lower than 2, preferably at least 50%, more preferred at least 70%, most preferred at least 80%. The method to measure the grade of peptization is generally described above.

In some embodiments, the boehmite product particles produced by the present invention have a crystallite size in the range of from about 10 to about 22 nm, more preferably in the range of from about 10 to about 19 nm. The crystallite size is determined by x-ray diffraction (“XRD”) as follows: X-Ray powder diffraction was carried out on a Siemens D500 with Bragg-Brentano focusing, applying a copper anode with a nickel filter for monochromatization. The crystallite size was calculated with the Scherrer equation: a=Kλ/β cos θ
a: crystallite size
λ: X-ray wavelength, CuKα=0.154 nm
β: FWHM (Full Width Half Maximum)
θ: reflection angle
K: coefficient, we assume K=1
   Further correction for apparative and physical influences on the peak broadening was not applied.

In some embodiments, the boehmite product particles of the present invention have an aspect ratio in the range of from about 1:1 to about 2:1. By aspect ratio, it is meant the ratio of the longest crystal dimension to the maximum length of the crystal perpendicular to the longest crystal dimension. For example, the aspect ratio of a perfect sphere is 1:1 since the diameter of the sphere is essentially the same in all measurements, e.g. the longest crystal dimension, in this case the diameter, is the same as the maximum length of the crystal perpendicular to the longest crystal dimension, which is again the diameter. Thus, it can be said that the boehmite product particles of the present invention approximate a sphere or are approximately spherical and thus have an aspect ratio less than 2:1. It should be noted that one having ordinary skill in the art will understand that not all of the boehmite particles of the present invention will have exactly the same aspect ratio, i.e. some of the particles are nearly spherical in shape but not a perfect sphere, and other particles are nearly a perfect sphere, i.e. have an aspect ratio of very near or 1:1. It should also be noted that since the boehmite product particles approximate a sphere, they possess no defined crystal face, and thus secondary aspect ratios do not apply.

### Use of the Boehmite Particles

The boehmite product particles produced by the present invention find use as flame retardant fillers in a variety of synthetic resins. Thus, in some embodiments, the present invention relates to flame retarded polymer formulations. In these embodiments, the flame retarded polymer formulations comprise a flame-retarding amount of boehmite particles as described above. By a flame-retarding amount of the boehmite particles, it is generally meant in the range of from about 0.1 to about 250 parts per hundred resin (“phr”), preferably in the range of from about 5 to about 150 phr. In a more preferred embodiment, a flame-retarding amount is in the range of from about 10 to about 120 phr. In a most preferred embodiment, a flame-retarding amount is in the range of from about 15 to about 80 phr.

The flame-retarding amount of boehmite particles according to the present invention can be used alone or in combination with other flame retardant additives. Non limiting examples of such flame retardant additives are aluminum hydroxide (ATH), magnesium hydroxide (MDH), huntite, hydromagnesite, layered double hydroxides, clays including organically modified clays (i.e. nano clays), halogen-containing flame retardants, phosphorus or organophosphorus compounds, nitrogen-containing flame retardants (e.g. melamine cyanurate) and the like. If other flame retardant fillers are also to be used, their amount is generally in the range from about 249.9 to about 0.1 parts (phr), relative to 100 parts (phr) of the synthetic resin.

The flame retarded polymer formulations of the present invention also comprise at least one, sometimes only one, synthetic resin. Non-limiting examples of synthetic resins include thermoplastics, elastomers and thermosets (uncured, or cured if required). In preferred embodiments, the synthetic resin is thermoplastic resin. Non-limiting examples of thermoplastic resins where the boehmite product particles find use include polyethylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, polycarbonate, polyamide, polyester resins (e.g. PBT), ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, vinyl chloride-propylene copolymer, vinyl acetate resin, phenoxy resin, and the like. Further examples of suitable synthetic resins include thermosetting resins such as epoxy resin, phenol resin, melamine resin, unsaturated polyester resin, alkyd resin and urea resin and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included. Further included are polymeric suspensions (lattices).

In some preferred embodiments, the at least one synthetic resin is a polyethylene-based resin such as high-density polyethylene, low-density polyethylene, linear low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (α-olefin) such as polybutene and poly(4-methylpentene-1), polyvinyl chloride and rubbers. In a more preferred embodiment, the synthetic resin is a polyethylene-based resin.

The flame retarded polymer formulations of the present invention can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; sodium stearate or calcium sterate; organoperoxides; dyes; pigments; fillers; blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants, in some embodiments magnesium hydroxides, aluminum hydroxides, phosphorus flame retardants, or halogen flame retardants; UV stabilizers; plasticizers; flow aids; and the like. If desired, nucleating agents such as calcium silicate or indigo can be included in the flame retarded polymer formulations also. The proportions of the other optional additives are conventional and can be varied to suit the needs of any given situation.

The methods of incorporation and addition of the components of the flame-retarded polymer formulation is not critical to the present invention and can be any known in the art so long as the method selected involves substantially uniform mixing of the components. For example, each of the above components, and optional additives if used, can be mixed using a Buss Ko-kneader, internal mixers, Farrel continuous mixers or twin screw extruders or in some cases also single screw extruders or two roll mills. The flame retarded polymer formulation can then be molded in a subsequent processing step, if so desired. In some embodiments, apparatuses can be used that thoroughly mix the components to form the flame retarded polymer formulation and also mold an article out of the flame retarded polymer formulation. Further, the molded article of the flame-retardant polymer formulation may be used after fabrication for applications such as stretch processing, emboss processing, coating, printing, plating, perforation or cutting. The molded article may also be affixed to a material other than the flame-retardant polymer formulation of the present invention, such as a plasterboard, wood, a block board, a metal material or stone. However, the kneaded mixture can also be inflation-molded, injection-molded, extrusion-molded, blow-molded, press-molded, rotation-molded or calender-molded.

In the case of an extruded article, any extrusion technique known to be effective with the synthetic resins mixture described above can be used. In one exemplary technique, the synthetic resin, boehmite particles, and optional components, if chosen, are compounded in a compounding machine to form a flame-retardant resin formulation as described above. The flame-retardant resin formulation is then heated to a molten state in an extruder, and the molten flame-retardant resin formulation is then extruded through a selected die to form an extruded article or to coat for example a metal wire or a glass fiber used for data transmission.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### Example 1

### Inventive

The aqueous bayerite/gibbsite suspension in water used in the following examples had a solid content of 98 g/l. The specific BET surface was 27.2 m²/g with a median d₅₀ particle size of 1.88 μm. The d₅₀ values were determined as described above.

At room temperature, 588 g of a pseudo-boehmite was mixed under intense stirring with 5292 g of deionized water to obtain a 10 wt % pseudo-boehmite suspension in water. 10 g of nitric acid (concentrated) was added dropwise until the pseudo-boehmite was 100% peptized to become a sol. The obtained pH value of the sol was 2. In a 50 l autoclave, 30 l of the bayerite/gibbsite suspension in water was poured. The solid content of the suspension was 98 g/l, and the total quantity of ATH particles in the suspension was 2940 g. The total amount of the boehmite sol, comprising water and nitric acid, was added to the autoclave, resulting in a boehmite sol/ATH ratio of 588 g/2940 g, which corresponds to 20%. As a crystal growth modifier, 500 g of a concentrated sodium hydroxide solution was added until a pH value of 12.5 was obtained. The suspension was then heated under stirring using a stirrer at a heat rate of about 3° C./min to a temperature of 200° C. and was maintained at that temperature for 1 h. The pressure in the autoclave was autogenous. The suspension was allowed to cool to about 50° C. while stirring, at a cooling rate of about 10° C./min. The suspension was then poured into a vessel to allow for further cooling to room temperature. After cooling to room temperature, 10 l of the boehmite particle suspension was filtered using filter paper. The filter cake thus obtained was then resuspended twice in 15 l of deionized water and filtered again. The washed filter cake was used to produce an aqueous suspension with a solid content of 10 wt. %. Approximately 200 g of acetic acid was then added dropwise while stirring until a pH value of 3.5 was obtained. Stirring was maintained for 10 min after a pH of 3.5 was reached using a stirrer at about 5000 rpm. Two liter of the obtained suspension comprising the boehmite sol, eventually unpeptized boehmite particles, water and acetic acid were then spray dried using a spray drier from the Büchi Company, type “B-290” thereby producing dried boehmite particles. The throughput of the spray drier was approx. 50 g/h solids, the inlet air temperature was about 220° C., and the outlet air temperature was about 73° C.

In order to measure the grade of peptizability of the dried boehmite particles, a suspension containing 10 wt. % of the dried boehmite particles was made in a beaker using a stirrer with 1 l of deionized water. Acetic acid was then added dropwise while stirring until a pH value of 3.5 was obtained. Stirring was maintained for 10 min using a stirrer at about 5000 rpm. From the obtained suspension comprising the boehmite sol, the unpeptized boehmite particles and acetic acid, the new total boehmite content in g per l of the suspension can be calculated by taking into account the quantity of the acetic acid added. From the obtained suspension comprising the boehmite sol, the unpeptized boehmite particles and acetic acid, 40 ml was removed from the beaker by means of a pipette, poured into a flask and centrifuged in a centrifuge at about 5000 rpm during 10 min. After centrifugation, the sol is removed by means of a pipette without picking up unpeptized boehmite particles sedimented at the bottom of the solution. The flask comprising the unpeptized boehmite particles was then dried in an oven at 105° C. during 24 h. The weight difference between the dried flask containing the dried, unpeptized boehmite particles and the weight of the empty flask gives the weight of the unpeptized boehmite particles present in the 40 ml of the suspension in the flask. The grade of peptization P is then obtained by dividing the weight difference between the total weight of the boehmite particles present in the 40 ml volume in the flask and the weight of the unpeptized boehmite particles by the weight of the total boehmite particles in the 40 ml volume. In the present example, a grade of peptization of 85% was obtained.

The following Table 1 summarizes the properties of the inventive boehmite grade.

TABLE 1

| | | | | 2% | 5% | |
|---|---|---|---|---|---|---|
| | Grade of | | | weight | weight | Crys- |
| | pepti- | | LOI at | loss | loss | tallite |
| | zation | BET | 1200° C. | temp. | temp. | size |
| | (%) | (m²/g) | (%) | (° C.) | (° C.) | (nm) |
| Example 1 | 85 | 89 | 18 | 300 | 376 | 13 |
| (Inventive) | | | | | | |

The crystal morphology of the boehmite particles of Example 1 was approximately spherical.

### Example 2

### Inventive

At room temperature, 588 g of a pseudo-boehmite was mixed under intense stirring with 5292 g of deionized water to obtain a 10 wt % pseudo-boehmite suspension in water. 10 g of nitric acid (concentrated) was added dropwise until the pseudo-boehmite was 100% peptized to become a sol. The obtained pH value of the sol was 2. In a 50 l autoclave, 30 l of the bayerite/gibbsite suspension in water was poured. The solid content of the suspension was 98 g/l, and the total quantity of ATH particles in the suspension was 2940 g. The total amount of the boehmite sol, comprising water and nitric acid, was added to the autoclave, resulting in a boehmite sol/ATH ratio of 588 g/2940 g, which corresponds to 20%. As a crystal growth modifier, 500 g of a concentrated sodium hydroxide solution was added until a pH value of 12.5 was obtained. The suspension was then heated under stirring using a stirrer at a heat rate of about 3° C./min to a temperature of 200° C. and was maintained at that temperature for 1 h. The pressure in the autoclave was autogenous. The suspension was allowed to cool to about 50° C. while stirring, at a cooling rate of about 10° C./min. The suspension was then poured into a vessel to allow for further cooling to room temperature. After cooling to room temperature, 10 l of the boehmite particle suspension was filtered using filter paper. The filter cake thus obtained was then resuspended twice in 15 l of deionized water and filtered again. The washed filter cake was used to produce an aqueous suspension with a solid content of 10 wt. %. Two liters of the obtained suspension were then spray dried using a spray drier from the Büchi Company, type “B-290” thereby producing dried boehmite particles. The throughput of the spray drier was approx. 50 g/h solids, the inlet air temperature was about 220° C., and the outlet air temperature was about 73° C.

In order to measure the grade of peptizability of the dried boehmite particles, a suspension containing 10 wt. % of the dried boehmite particles was made in a beaker using a stirrer with 1 l of deionized water. Acetic acid was then added dropwise while stirring until a pH value of 3.5 was obtained. Stirring was maintained for 10 min using a stirrer at about 5000 rpm. From the obtained suspension comprising the boehmite sol, the unpeptized boehmite particles and acetic acid, the new total boehmite content in g per l of the suspension can be calculated by taking into account the quantity of the acetic acid added. From the obtained suspension comprising the boehmite sol, the unpeptized boehmite particles and acetic acid, 40 ml was removed from the beaker by means of a pipette, poured into a flask and centrifuged in a centrifuge at about 5000 rpm during 10 min. After centrifugation, the sol is removed by means of a pipette without picking up unpeptized boehmite particles sedimented at the bottom of the solution. The flask comprising the unpeptized boehmite particles was then dried in an oven at 105° C. during 24 h. The weight difference between the dried flask containing the dried, unpeptized boehmite particles and the weight of the empty flask gives the weight of the unpeptized boehmite particles present in the 40 ml of the suspension in the flask. The grade of peptization P is then obtained by dividing the weight difference between the total weight of the boehmite particles present in the 40 ml volume in the flask and the weight of the unpeptized boehmite particles by the weight of the total boehmite particles in the 40 ml volume. In the present example, a grade of peptization of 81% was obtained.

The following Table 2 summarizes the properties of the inventive boehmite grade.

TABLE 2

| | | | | 2% | 5% | |
|---|---|---|---|---|---|---|
| | Grade of | | | weight | weight | Crys- |
| | pepti- | | LOI at | loss | loss | tallite |
| | zation | BET | 1200° C. | temp. | temp. | size |
| | (%) | (m²/g) | (%) | (° C.) | (° C.) | (nm) |
| Example 2 | 81 | 109 | 16 | 300 | 387 | 13 |
| (Inventive) | | | | | | |

The crystal morphology of the boehmite particles of Example 2 was approximately spherical.

### Example 3

### Comparative

At room temperature, 588 g of a pseudo-boehmite was mixed under intense stirring with 5292 g of deionized water to obtain a 10 wt % pseudo-boehmite suspension in water. In a 50 l autoclave, 30 l of the bayerite/gibbsite suspension in water was poured. The solid content of the suspension was 98 g/l, and the total quantity of ATH particles in the suspension was 2940 g. The total amount of the boehmite suspension, comprising unpeptized pseudo-boehmite and water, was added to the autoclave, resulting in a boehmite/ATH ratio of 588 g/2940 g, which corresponds to 20%. As a crystal growth modifier, 200 g of a concentrated sodium hydroxide solution was added until a pH value of 12.5 was obtained. The suspension was then heated under stirring using a stirrer at a heat rate of about 3° C./min to a temperature of 200° C. and was maintained at that temperature for 1 h. The pressure in the autoclave was autogenous. The suspension was allowed to cool to about 50° C. while stirring, at a cooling rate of about 10° C./min. The suspension was then poured into a vessel to allow for further cooling to room temperature. After cooling to room temperature, 10 l of the boehmite particle suspension was filtered using filter paper. The filter cake thus obtained was then resuspended twice in 15 l of deionized water and filtered again. The washed filter cake was used to produce an aqueous suspension with a solid content of 10 wt. %. Acetic acid was then added dropwise while stirring until a pH value of 3.5 was obtained. Stirring was maintained during 10 min using a stirrer at about 5000 rpm. Two liter of the obtained suspension comprising the boehmite sol, eventually unpeptized boehmite particles, water and acetic acid were then spray dried using a spray drier from the Büchi Company, type “B-290”, thereby producing dried boehmite particles. The throughput of the spray drier was approx. 50 g/h solids, the inlet air temperature was about 220° C., and the outlet air temperature was about 73° C.

In order to measure the grade of peptizability of the dried boehmite particles, a suspension containing 10 wt. % of the dried boehmite particles was made in a beaker using a stirrer with 1 l of deionized water. Acetic acid was then added dropwise while stirring until a pH value of 3.5 was obtained. Stirring was maintained for 10 min using a stirrer at about 5000 rpm. From the obtained suspension comprising the boehmite sol, the unpeptized boehmite particles and acetic acid, the new total boehmite content in g per l of the suspension can be calculated by taking into account the quantity of the acetic acid added. From the obtained suspension comprising the boehmite sol, the unpeptized boehmite particles and acetic acid, 40 ml was removed from the beaker by means of a pipette, poured into a flask and centrifuged in a centrifuge at about 5000 rpm during 10 min. After centrifugation, the sol is removed by means of a pipette without picking up unpeptized boehmite particles sedimented at the bottom of the solution. The flask comprising the unpeptized boehmite particles was then dried in an oven at 105° C. during 24 h. The weight difference between the dried flask containing the dried, unpeptized boehmite particles and the weight of the empty flask gives the weight of the unpeptized boehmite particles present in the 40 ml of the suspension in the flask. The grade of peptization P is then obtained by dividing the weight difference between the total weight of the boehmite particles present in the 40 ml volume in the flask and the weight of the unpeptized boehmite particles by the weight of the total boehmite particles in the 40 ml volume. In the present example, a grade of peptization of 5% was obtained.

The following Table 3 summarizes the properties of the non-inventive boehmite grade.

TABLE 3

| | Grade | | | 2% | 5% | |
|---|---|---|---|---|---|---|
| | of | | | weight | weight | Crys- |
| | pepti- | | LOI at | loss | loss | tallite |
| | zation | BET | 1200° C. | temp. | temp. | size |
| | (%) | (m²/g) | (%) | (° C.) | (° C.) | (nm) |
| Example 3 | 5 | 23 | 20 | 350 | 424 | 30 |
| (Comparative) | | | | | | |

The crystal morphology of the boehmite particles of Example 3 was irregular platelet.

### Example 4

### Comparative

In a 50 l autoclave, 37 l of the bayerite/gibbsite suspension in water was poured. The solid content of the suspension was 98 g/l, and the total quantity of ATH particles in the suspension was 3626 g. As a crystal growth modifier, 200 g of a concentrated sodium hydroxide solution was added until a pH value of 12.5 was obtained. The suspension was then heated under stirring using a stirrer at a heat rate of about 3° C./min to a temperature of 200° C. and was maintained at that temperature for 1 h. The pressure in the autoclave was autogenous. The suspension was allowed to cool to about 50° C. while stirring, at a cooling rate of about 10° C./min. The suspension was then poured into a vessel to allow for further cooling to room temperature. After cooling to room temperature, 10 l of the boehmite particle suspension was filtered using filter paper. The filter cake thus obtained was then resuspended twice in 15 l of deionized water and filtered again. The washed filter cake was used to produce an aqueous suspension with a solid content of 10 wt. %. 2 l of the obtained suspension were then spray dried using a spray drier from the Büchi Company, type “B-290”. The throughput of the spray drier was approx. 50 g/h solids, the inlet air temperature was about 220° C., and the outlet air temperature was about 73° C.

A suspension containing 10 wt. % of boehmite particles was made in a beaker using a stirrer with 1 l of deionized water and dried boehmite particles. Acetic acid was then added dropwise while stirring until a pH value of 3.5 was obtained. Stirring was maintained during 10 min using a stirrer at 5000 rpm. From the obtained solution comprising the boehmite sol, the boehmite particles and acetic acid, the new total boehmite content in g per l of the solution can be calculated by taking into account the quantity of the acetic acid added. From the obtained solution comprising the boehmite sol, the boehmite particles and acetic acid, 40 ml was removed from the beaker by means of a pipette, poured into a flask and centrifuged in a centrifuge at about 5000 rpm during 10 min. After centrifugation, the sol is removed by means of a pipette without picking up boehmite particles sedimented at the bottom of the solution. The flask comprising the unpeptized boehmite particles was then dried in an oven at 105° C. during 24 h. The weight difference between the dried flask containing the dried, unpeptized boehmite particles and the weight of the empty flask gives the weight of the unpeptized boehmite particles present in the 40 ml of the suspension in the flask. The grade of peptization P is then obtained by dividing the weight difference between the total weight of the boehmite particles present in the 40 ml volume in the flask and the weight of the unpeptized boehmite particles by the weight of the total boehmite particles in the 40 ml volume. In the present example, a grade of peptization of 2% was obtained.

The following Table 4 summarizes the properties of the non-inventive boehmite grade.

TABLE 4

| | Grade | | | 2% | 5% | |
|---|---|---|---|---|---|---|
| | of | | | weight | weight | Crys- |
| | pepti- | | LOI at | loss | loss | tallite |
| | zation | BET | 1200° C. | temp. | temp. | size |
| | (%) | (m²/g) | (%) | (° C.) | (° C.) | (nm) |
| Example 4 | 2 | 14 | 20 | 398 | 454 | 32 |
| (Comparative) | | | | | | |

The crystal morphology of the boehmite particles of Example 4 was irregular platelet.

### Example 5

### Application-Inventive

100 phr (about 284.5 g) of ethylene vinyl acetate (EVA) Escorene™ Ultra UL00119 from ExxonMobil was mixed for about 20 min on a two-roll mill W150M from the Collin Company with 75 phr (about 213.4 g) of the inventive boehmite filler produced in Example 1. Mixing on the two-roll mill was done in a usual manner familiar to a person skilled in the art, together with 0.75 phr (about 2.1 g) of the antioxidant Ethanox® 310 from Albemarle Corporation. The temperature of the two rolls was set to 130° C. The ready compound was removed from the mill, and after cooling to room temperature, was further reduced in size to obtain granulates suitable for compression molding in a two platen press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder.

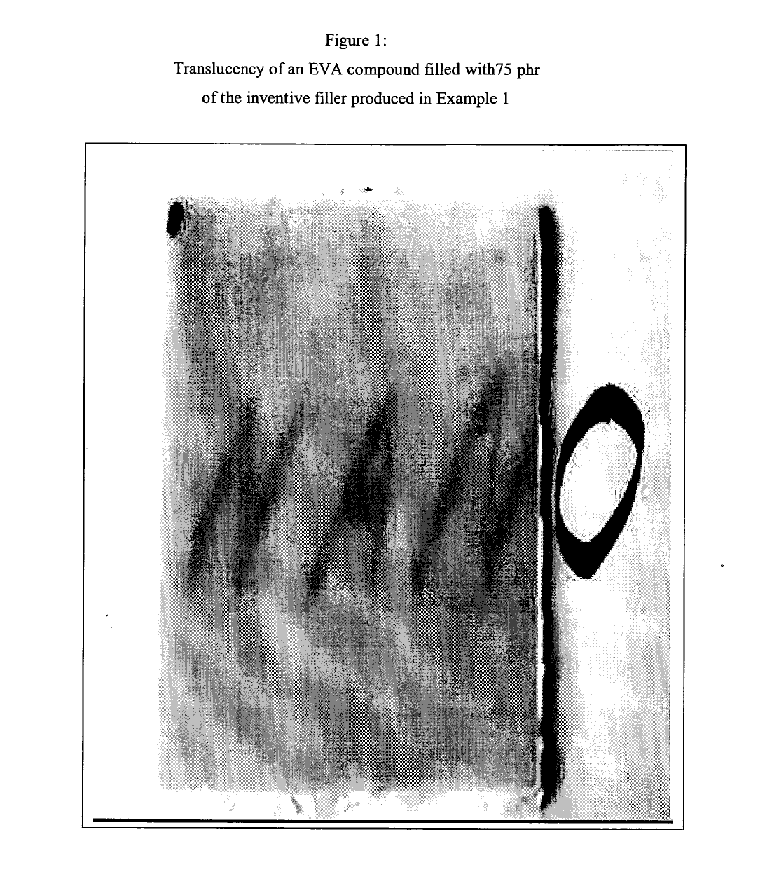

FIG. 1 shows the translucency of a 3 mm thick plate of this EVA compound, filled with 75 phr of the inventive boehmite filler produced in Example 1.

The mechanical and the flame retardant properties of this experiment are contained in Table 5, below.

### Example 6

### Application-Inventive

100 phr (about 284.5 g) of ethylene vinyl acetate (EVA) Escorene™ Ultra UL00119 from ExxonMobil was mixed for about 20 min on a two-roll mill W150M from the Collin Company with 75 phr (about 213.4 g) of the inventive boehmite filler produced in Example 2. Mixing on the two-roll mill was done in a usual manner familiar to a person skilled in the art, together with 0.75 phr (about 2.1 g) of the antioxidant Ethanox® 310 from Albemarle Corporation. The temperature of the two rolls was set to 130° C. The ready compound was removed from the mill, and after cooling to room temperature, was further reduced in size to obtain granulates suitable for compression molding in a two platen press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder.

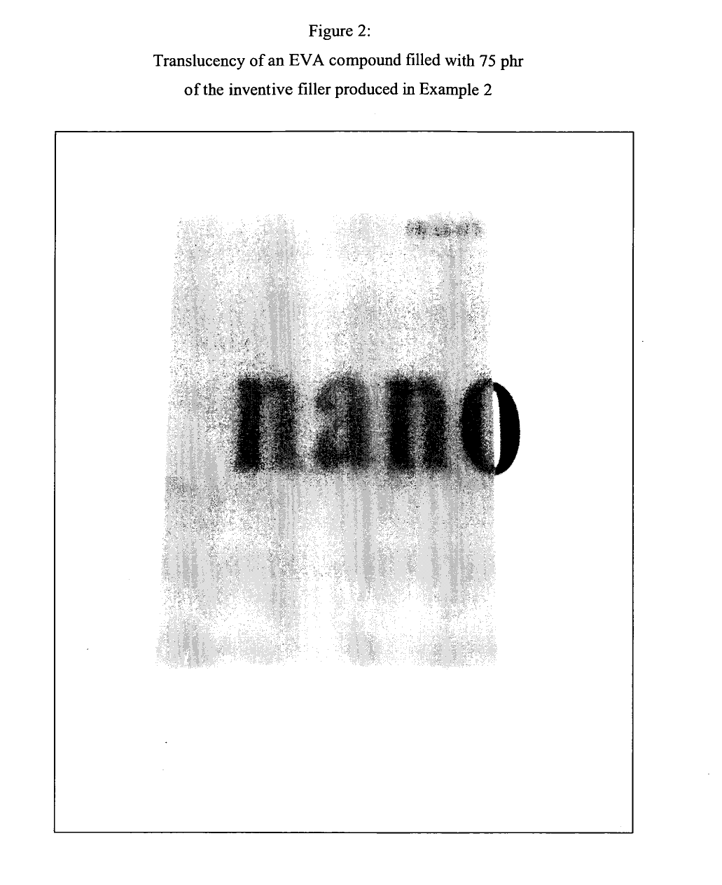

FIG. 2 shows the translucency of a 3 mm thick plate of this EVA compound, filled with 75 phr of the inventive boehmite filler produced in Example 2.

The mechanical and the flame retardant properties of this experiment are contained in Table 5, below.

### Example 7

### Application-Comparative

100 phr (about 284.5 g) of ethylene vinyl acetate (EVA) Escorene™ Ultra UL00119 from ExxonMobil was mixed for about 20 min on a two-roll mill W150M from the Collin Company with 75 phr (about 213.4 g) of the comparative boehmite filler produced in Example 3. Mixing on the two-roll mill was done in a usual manner familiar to a person skilled in the art, together with 0.75 phr (about 2.1 g) of the antioxidant Ethanox® 310 from Albemarle Corporation. The temperature of the two rolls was set to 130° C. The ready compound was removed from the mill, and after cooling to room temperature, was further reduced in size to obtain granulates suitable for compression molding in a two platen press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder.

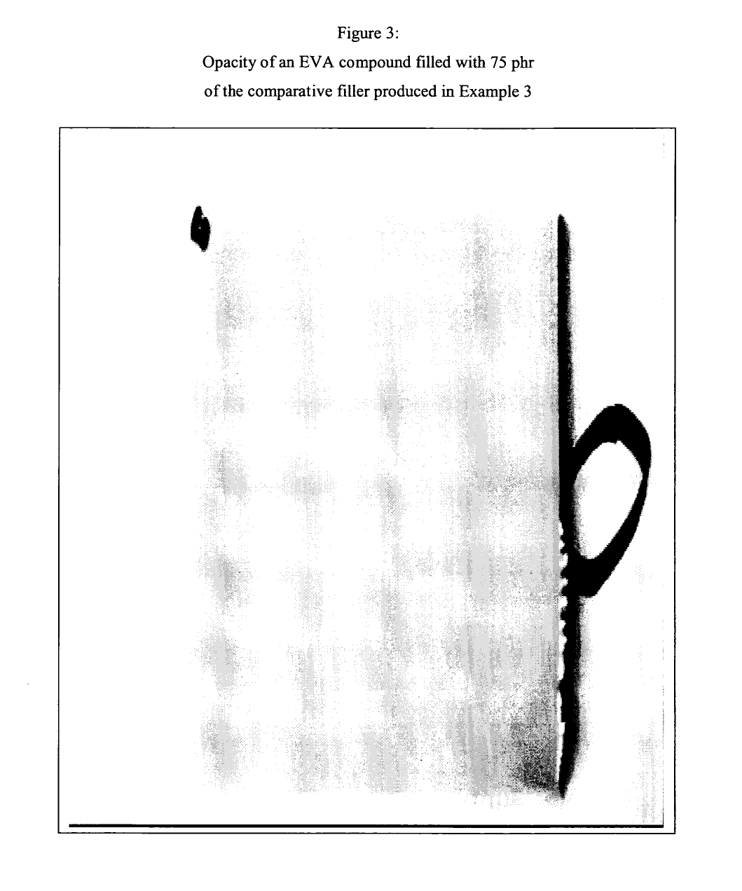

FIG. 3 shows the opacity of a 3 mm thick plate of this EVA compound, filled with 75 phr of the comparative boehmite filler produced in Example 3.

The mechanical and the flame retardant properties of this experiment are contained in Table 5, below.

### Example 8

### Application-Comparative

100 phr (about 284.5 g) of ethylene vinyl acetate (EVA) Escorene™ Ultra UL00119 from ExxonMobil was mixed for about 20 min on a two-roll mill W150M from the Collin Company with 75 phr (about 213.4 g) of the comparative boehmite filler produced in Example 4. Mixing on the two-roll mill was done in a usual manner familiar to a person skilled in the art, together with 0.75 phr (about 2.1 g) of the antioxidant Ethanox® 310 from Albemarle Corporation. The temperature of the two rolls was set to 130° C. The ready compound was removed from the mill, and after cooling to room temperature, was further reduced in size to obtain granulates suitable for compression molding in a two platen press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder.

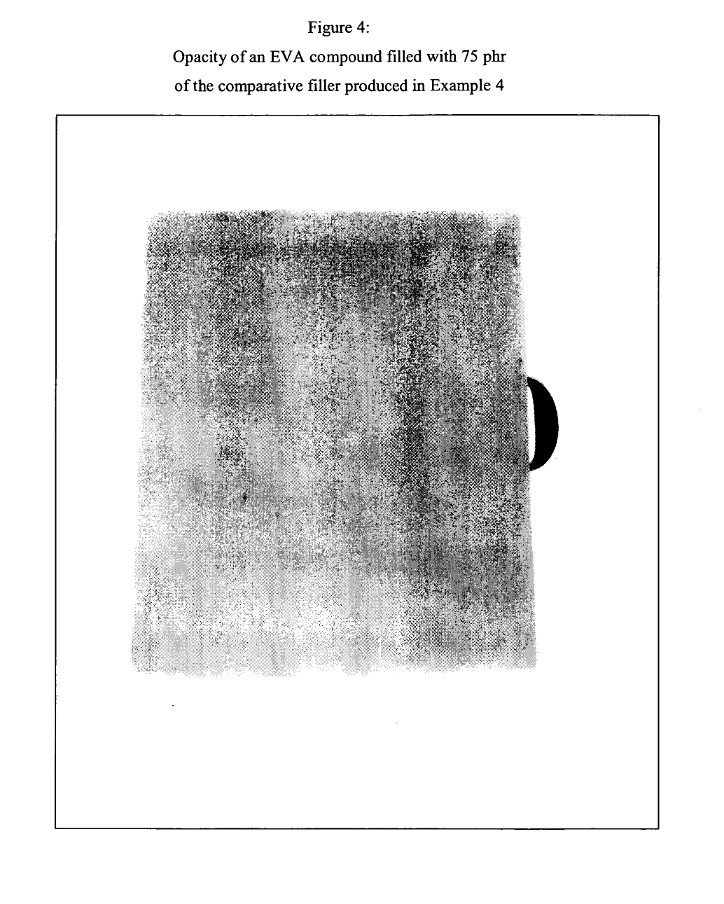

FIG. 4 shows the opacity of a 3 mm thick plate of this EVA compound, filled with 75 phr of the comparative boehmite filler produced in Example 4.

### Example 9

### Application-Comparative

100 phr (about 284.5 g) of ethylene vinyl acetate (EVA) Escorene™ Ultra UL00119 from ExxonMobil was mixed for about 20 min on a two roll mill W150M from the Collin company with 75 phr (about 213.4 g) of the comparative commercially available magnesium hydroxide filler Magnifin H 5 from Martinswerk GmbH. Mixing on the two-roll mill was done in a usual manner familiar to a person skilled in the art, together with 0.75 phr (about 2.1 g) of the antioxidant Ethanox® 310 from Albemarle Corporation. The temperature of the two rolls was set to 130° C. The ready compound was removed from the mill, and after cooling to room temperature, was further reduced in size to obtain granulates suitable for compression molding in a two platen press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder.

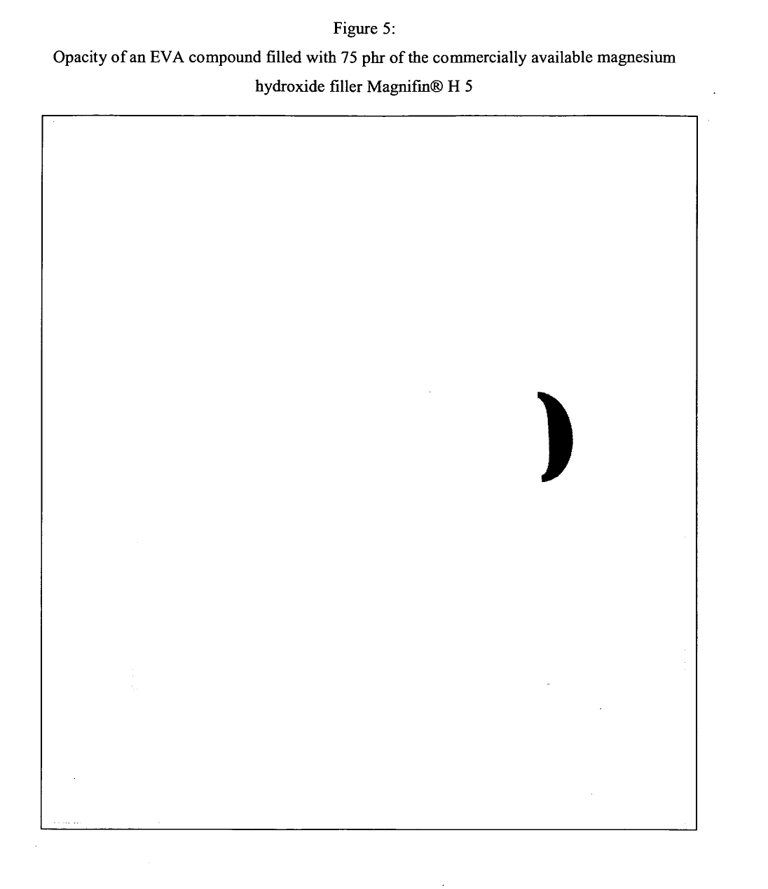

FIG. 5 shows the opacity of a 3 mm thick plate of this EVA compound, filled with 75 phr of the commercially available magnesium hydroxide filler Magnifin H 5.

### Example 10

### Application-Comparative

100 phr (about 284.5 g) of ethylene vinyl acetate (EVA) Escorene™ Ultra UL00119 from ExxonMobil was mixed for about 20 min on a two roll mill W150M from the Collin company with 75 phr (about 213.4 g) of the comparative commercially available aluminum hydroxide filler Martinal OL 104 LE from Martinswerk GmbH. Mixing on the two-roll mill was done in a usual manner familiar to a person skilled in the art, together with 0.75 phr (about 2.1 g) of the antioxidant Ethanox® 310 from Albemarle Corporation. The temperature of the two rolls was set to 130° C. The ready compound was removed from the mill, and after cooling to room temperature, was further reduced in size to obtain granulates suitable for compression molding in a two platen press or for feeding a laboratory extruder to obtain extruded strips for further evaluation. In order to determine the mechanical properties of the flame retardant resin formulation, the granules were extruded into 2 mm thick tapes using a Haake Polylab System with a Haake Rheomex extruder.

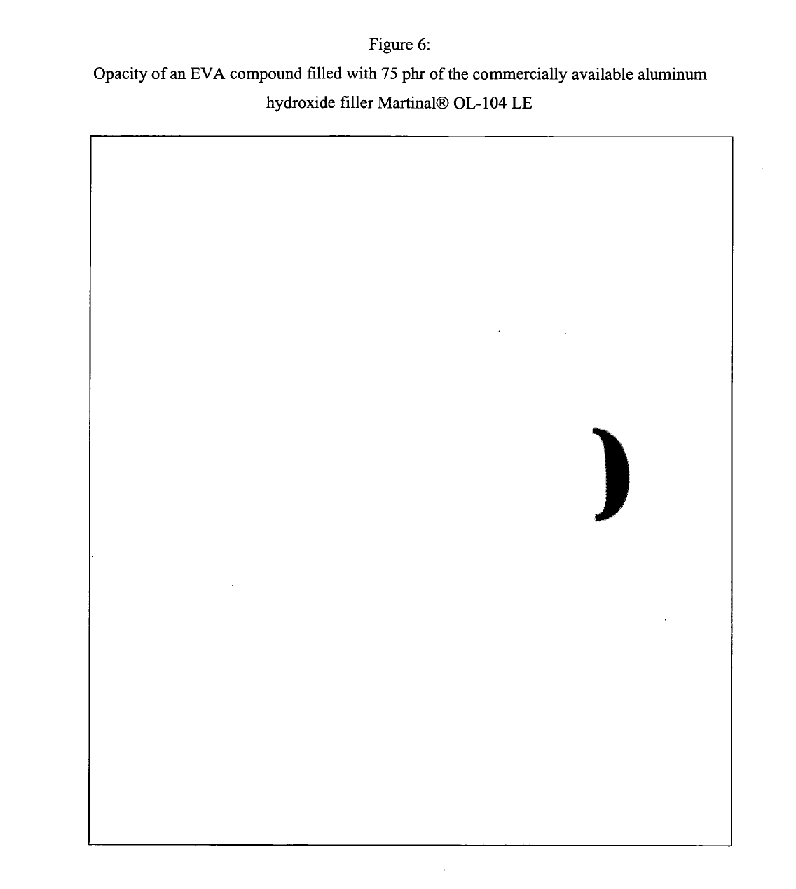

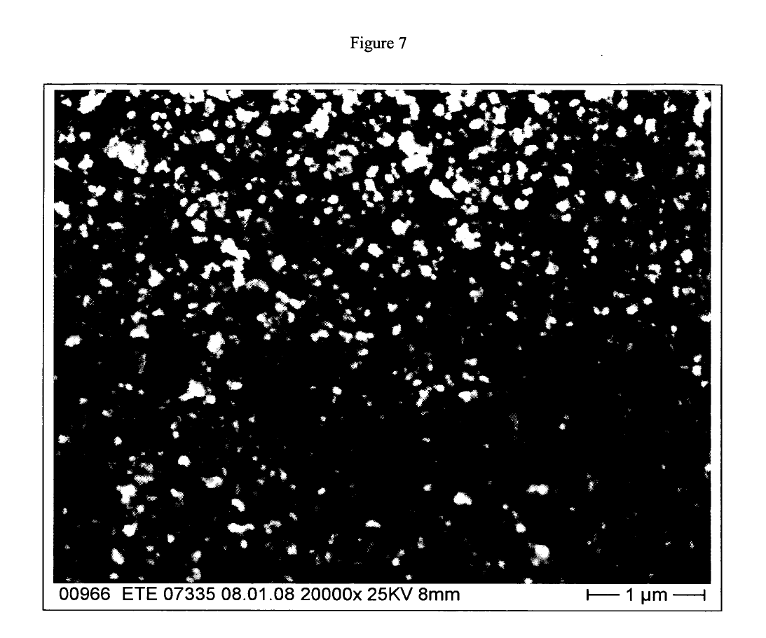

FIG. 6 shows the opacity of a 3 mm thick plate of this EVA compound, filled with 75 phr of the commercially available aluminum hydroxide filler Martinal OL-104 LE.

TABLE 5

| | Ex. 5 | Ex. 6 | Ex. 7 | Ex. 8 | Ex. 9 | Ex. 10 |
|---|---|---|---|---|---|---|
| | (Appl.- | (Appl.- | (Appl.- | (Appl.- | (Appl.- | (Appl.- |
| | Inventive) | Inventive) | Comp.) | Comp.) | Comp.) | Comp.) |
| Tensile strength (MPa) | 18.3 | 12.8 | 10.6 | 11.9 | 8.6 | 14 |
| Elongation at break (%) | 894 | 429 | 703 | 140 | 600 | 978 |
| Peak Heat Release | 211 | 185 | 233 | 270 | 449 | 374 |
| Rate PHRR (kW/m²) | | | | | | |
| Time to Ignition TTI (s) | 79 | 90 | 75 | 79 | 106 | 89 |
| Fire Performance Index | 0.37 | 0.49 | 0.32 | 0.29 | 0.24 | 0.24 |
| FPI = TTI/PHRR | | | | | | |
| (m²s/kW) | | | | | | |
| Translucent (3 mm | Yes | Yes | No | No | No | No |
| EVA plate) | | | | | | |

The tensile strength & elongation at break was measured in accordance with DIN 53504 & EN ISO 527, cone calorimetry measurements were made according to ASTM E 1354 at 35 kW/m² on 3 mm thick compression molded plates. The Peak Heat Release Rate (PHRR) shown in Table 5 is the maximum value of the heat released during combustion of the sample in the cone calorimeter. A lower PHRR value indicates a better flame retardancy. The Time To Ignition (TTI) value in Table 5 is the time when the sample ignites due to heat exposure in the cone calorimeter. The fire performance Index FPI is defined as the quotient of the time to ignition value and the peak heat release rate and thus combines both quantities. It is obvious that a higher value for the FPI indicates a better flame retardancy.

It follows from Table 5 that translucency and highest FPI values are to be obtained for the inventive fillers only. The comparative application Examples 9 and 10 also shows that the new inventive boehmite grades are more efficient flame-retardants: the FPI is lowest for the commercially available magnesium and aluminum hydroxide grades.

### Example 11

### Translucency of Compounds

In an effort to better demonstrate some of the benefits that can be achieved through the use of processes and products according to the present invention, the translucency of several compounds produced in the preceding examples was quantified by measurements of transparency with the Elrepho 2000 (Electric Reflectance Photometer) from the company Datacolor according to DIN 53147. Values for plates of 2 mm thickness, filler level 75 phr (43%) are in Table 6.

TABLE 6

| | Transparency - % |
|---|---|
| Sample | DIN 53147 |
| Example 6 (inventive) | 64.1 |
| Example 7 (comparative) | 19.4 |
| Example 10 (comparative) | 7.4 |
| EVA Escorene ™ Ultra UL00119 (no filler) | 94.1 |

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention described and claimed herein is not to be limited in scope by the specific examples and embodiments herein disclosed, since these examples and embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fail within the scope of the appended claims.

1. A process comprising heating a mixture containing at least aluminum hydroxide particles (“ATH”) and in the range of from about 1 to about 40 wt % of an at least partially peptized boehmite, based on the total weight of the aluminum hydroxide particles, in the presence of water and one or more base crystal growth regulators to one or more temperatures of at least about 160° C. for a period of time of up to about 2 days thereby producing an aqueous product suspension comprising at least boehmite product particles, wherein said boehmite product particles have an aspect ratio in the range of less than about 2:1.

2. The process of claim 1, wherein the amount of said base crystal growth regulator in said mixture results in a pH ranging from about 10 to about 14.

3-7. (canceled)

8. The process according to claim 1 wherein the ATH particles are pure gibbsite or a bayerite-/gibbsite mixture.

9-11. (canceled)

12. The process according to claim 1 wherein the at least partly peptizable boehmite, before it is peptized, is characterized as having a BET in the range of from about 70 to about 400 m²/g and is peptizable by at least about 30%, and a d₅₀ greater than 0.02 μm.

13. (canceled)

14. The process according to claim 8 wherein the mixture is heated to one or more temperatures in the range of from about 160° C. to about 340° C. at one or more pressures above about atmospheric pressure.

15-18. (canceled)

19. The process according to claim 1 wherein an acid or base is added to the aqueous product suspension before drying to at least partly peptize the boehmite product particles in the aqueous product solution, wherein the amount of acid added to the aqueous product suspension is that amount sufficient to achieve and/or maintain a pH value of the aqueous product solution within the range of from about 1 to about 5 or the amount of base added to the aqueous product suspension is that amount sufficient to achieve and/or maintain a pH value of the aqueous product solution within the range of from about 10 to 14.

20. The process according to claim 19 wherein said process further comprises:
a) re-slurrying the boehmite product particles with water, a dispersing agent, or a combination thereof thereby producing a first boehmite product particle suspension; adding an acid or base to the boehmite product particle suspension thereby producing a second boehmite product particle suspension containing at least partially peptized boehmite product particles, wherein the amount of acid added to the first boehmite product particle suspension is that amount sufficient to achieve and/or maintain a pH within the range of from about 1 to about 5 or the amount of base used will be such that the resulting pH value of the second boehmite product particle suspension is in the range of from about 10 to 14; and
b) recovering and optionally drying the at least partially peptized boehmite product particles.

21. The process according to claim 1 wherein the boehmite product particles are characterized by:
a) a BET specific surface area, as determined by DIN-66132, in the range of from about 20 to about 300 m²/g, a maximum loss on ignition (LOI) of 20% at a temperature of 1200° C., a crystallite size between 10 and 25 nm, and an aspect ratio of less than about 2:1; or
b) a BET specific surface in the range of from about 50 to about 200 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., a crystallite size between 10 and 22 nm, and an aspect ratio in the range of from about 1:1 to about 2:1; or
c) a BET specific surface in the range of from about 70 to about 180 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., a crystallite size between 10 and 22 nm, and an aspect ratio in the range of from about 1:1 to about 2:1; or
d) a BET specific surface in the range of from about 80 to about 150 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., a crystallite size between 10 and 19 nm, and an aspect ratio in the range of from about 1:1 to about 2:1.

22. The process according to claim 19 wherein the boehmite product particles are characterized by:
a) a BET specific surface area, as determined by DIN-66132, in the range of from about 20 to about 300 m²/g, a maximum loss on ignition (LOI) of 20% at a temperature of 1200° C., a crystallite size between 10 and 25 nm, and an aspect ratio of less than about 2:1; or
b) a BET specific surface in the range of from about 50 to about 200 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., a crystallite size between 10 and 22 nm, and an aspect ratio in the range of from about 1:1 to about 2:1; or
c) a BET specific surface in the range of from about 70 to about 180 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., a crystallite size between 10 and 22 nm, and an aspect ratio in the range of from about 1:1 to about 2:1; or
d) a BET specific surface in the range of from about 80 to about 150 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., a crystallite size between 10 and 19 nm, and an aspect ratio in the range of from about 1:1 to about 2:1.

23-25. (canceled)

26. A process comprising heating a mixture containing at least aluminum hydroxide particles (“ATH”) and in the range of from about 1 to about 40 wt % of an at least partially peptized boehmite, based on the total weight of the aluminum hydroxide particles, in the presence of water and one or more base crystal growth regulators to one or more temperatures of at least about 160° C. for a period of time of up to about 2 days thereby producing an aqueous product suspension comprising at least boehmite product particles, wherein said boehmite product particles are approximately spherical.

27. Boehmite particles having an aspect ratio of less than 2:1 that are peptizable by at least 30% using acetic acid at a pH value not lower than 2 and further characterized by:
a) a BET specific surface area, as determined by DIN-66132, in the range of from about 20 to about 300 m²/g, a maximum loss on ignition (LOI) of 20% at a temperature of 1200° C., and a crystallite size between 10 and 25 nm; or
b) a BET specific surface in the range of from about 50 to about 200 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1.200° C., and a crystallite size between 10 and 22 nm; or
c) a BET specific surface in the range of from about 70 to about 180 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., and a crystallite size between 10 and 22 nm; or
d) a BET specific surface in the range of from about 80 to about 150 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., and a crystallite size between 10 and 19 nm.

28-32. (canceled)

33. A flame retarded formulation comprising:
a) a flame retarding amount of boehmite particles that have an aspect ratio of less than about 2:1 and are peptizable by at least 30% using acetic acid at a pH value not lower than 2 in an aqueous solution containing a solid content of 10 wt % wherein said boehmite particles are further characterized by:
b) a BET specific surface area, as determined by DIN -66132, in the range of from about 20 to about 300 m²/g, a maximum loss on ignition (LOI) of 20% at a temperature of 1200° C., and a crystallite size between 10 and 25 nm; or
c) a BET specific surface in the range of from about 50 to about 200 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., and a crystallite size between 10 and 22 nm; or
d) a BET specific surface in the range of from about 70 to about 180 m²/g, a 2% weight loss at a temperature equal or higher than about 250° C., and a 5% weight loss at a temperature equal or higher than about 330° C. as determined by TGA, a maximum a loss on ignition (LOI) of 20% at a temperature of 1200° C., and a crystallite size between 10 and 22 nm; or
e) a BET specific surface in the range of from about 80 to about 150 m²/g, a 2% weight loss at a temperature equal or higher than about 250° C., and a 5% weight loss at a temperature equal or higher than about 330° C. as determined by TGA, a maximum loss on ignition (LOI) of 20% at a temperature of 1200° C., and a crystallite size between 10 and 19 nm;
f) at least one synthetic resin; and, optionally,
g) one or more additives selected from additional flame retardants; extrusion aids;
coupling agents; sodium stearate or calcium sterate; organoperoxides; dyes; pigments; fillers;
blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants, in some embodiments magnesium hydroxides, aluminum hydroxides, phosphorus flame retardants, or halogen flame retardants; UV stabilizers; plasticizers; flow aids; and the like.

34-40. (canceled)
